(19) United States
(12) Patent Application Publication
(10) Pub. No.: US 2026/0353101 A1
(43) Pub. Date: Nov. 5, 2026

(54) COMMUNICATION NETWORKS INCLUDING MODULAR, DISTRIBUTED MICRO-EDGE COMPUTING RADIO NETWORK INSTALLATIONS

(71) Applicant: Dimitrios Lalos, St. Charles, IL (US)

(72) Inventor: Dimitrios Lalos, St. Charles, IL (US)

(21) Appl. No.: 19/478,306

(22) PCT Filed: Apr. 29, 2024
(86) PCT No.: PCT/US2024/026736

§ 371 Date: Oct. 24, 2025

Related U.S. Application Data
(60) Provisional application No. 63/498,585, filed on Apr. 27, 2023.

(51) Int. Cl. H04W 16/18; H04W 88/08

(52) U.S. Cl. CPC H04W 16/18; H04W 88/085

(57) ABSTRACT

A network includes a plurality of modular edge computing radio network (μ-MECRN) installations which may be scaleable over at least two domains to increase wireless communication capacity and mobile edge computing capability. The network may be further scaleable over additional domains by addition of μ-MECRN, increased fiber-optic coupling of μ-MECRN with other μ-MECRN, repeaters, or macro-sites.

### CROSS-REFERENCE TO RELATED APPLICATIONS

The present application claims the benefit of and priority to U.S. Application No. 63/498,585, filed Apr. 27, 2023, and the same is incorporated herein by reference.

### TECHNICAL FIELD

The present application relates to communication networks including modular, distributed micro-edge computing radio network installations and related apparatuses, methods, systems, and techniques.

### BACKGROUND

A number of proposals have been made for implementing and radio networks such as cellular communication networks. A number of proposals have been made for implementing edge computing systems. Extant proposals suffer from a number of disadvantages, drawbacks, limitations, and shortcomings, including those respecting infrastructure footprint, efficiency, limited functionality, flexibility, modifiability, and others. There remains a significant unmet need for the apparatuses, methods, systems, and techniques disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention includes and protects such alterations, modifications, and further applications of the example embodiments as would occur to one skilled in the art.

### BRIEF DESCRIPTION OF THE DRAWINGS

FIG. 1 is a schematic diagram illustrating certain aspects of an example communication network.

FIG. 2A-2E are schematic diagrams illustrating certain aspects a modular edge computing radio network installation in a plurality of states of deployment.

FIGS. 3-7 are schematic diagrams illustrating certain aspects of the communication network of FIG. 1 in a plurality of states of deployment.

### DETAILED DESCRIPTION OF EXAMPLE EMBODIMENTS

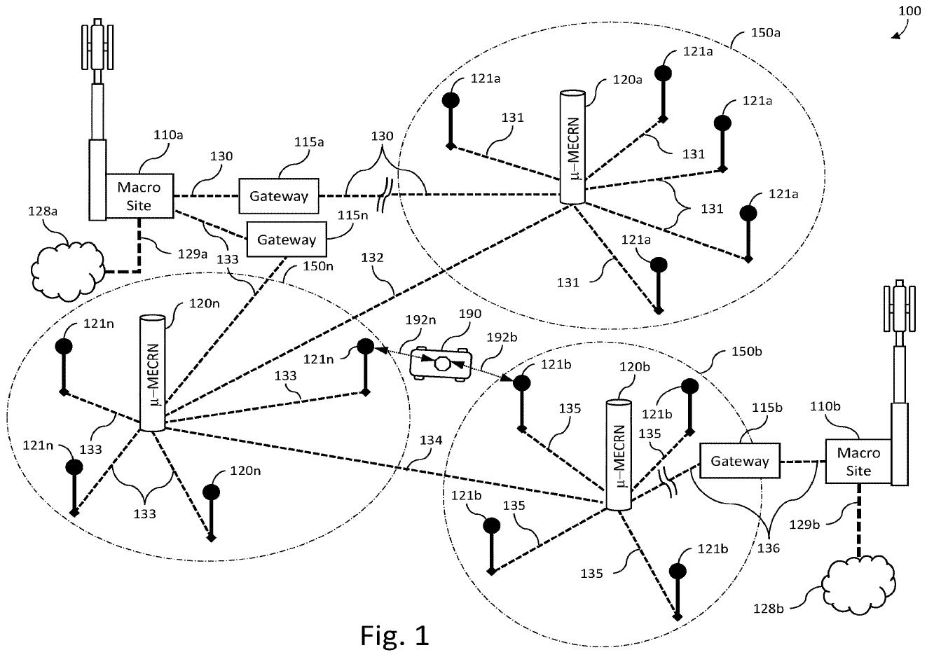

With reference to FIG. 1, there is illustrated an example communication network 100 (also referred to herein as network 100). While network 100 is illustrated and described in the singular, it shall be appreciated that network 100 may comprise a plurality networks each of which is in operative communication with at least one other of the plurality of networks.

Network 100 includes a plurality of micro-modular edge computing radio network installations 120a, 120b, and 120n (also referred to herein as μ-MECRN). While the illustrated example depicts three μ-MECRN 120a, 120b, 120n, it shall be appreciated that the present disclosure contemplates networks including a greater or lesser number of μ-MECRN. Additionally, while μ-MECRN 120a, 120b, 120n are illustrated as being connected to a number of other components of network 100, it shall be appreciated that the illustrated connections are but one example, and that a variety of other connections are contemplated.

μ-MECRN 120a may be operatively connected to macro-site 110a by one or more fiber-optic communication lines 130 and a gateway 115a which is configured and operable to manage communication between a network domain of μ-MECRN 120a and a network domain of macro-site 110a. The illustrated embodiment depicts a single gateway 115a with particular positioning and connectivity relationships with the one or more fiber-optic communication lines 130. It shall be appreciated that other embodiments may include a plurality of gateways and that one or more gateways associated with fiber-optic communication lines 130 may be provided with other positioning and/or other connectivity relationships with the one or more fiber-optic communication lines 130.

Macro-site 110a may include radio network components and resources such as those of a full size cellular base station and tower also referred to as a macrocell. Macro-site 110a may also be provided with edge computing components and resources. It shall be appreciated that a micro-site such as μ-MECRN 120a or the other μ-MECRN described herein may be distinguished from a macro-site such as macro-site 110a or the other macro-sites based upon a number of characteristics.

In one respect the geographic area of wireless service provided by a macro-site may have a radius on the order of 1.5-2 miles. In contrast, the geographic area of wireless service provided by a micro-site may have a radius on the order of 0.1-0.2 miles for an individual μ-MECRN or 0.25-0.5 miles for a μ-MECRN in combination with or more repeaters.

In another respect, a macro-site may include a radio tower on the order of 50-200 feet in height. A micro-site may include tower structure of 50 feet or less, 30 feet or less, 25, feet or less, or 20 feet or less.

In another respect, a macro-site generally includes multiple structural footprints such as a footprint of a freestanding tower and footprint separate electronics compartment or housing which may be adjacent or proximate the freestanding tower. A micro-site may comprise a single footprint installation. In another respect a macro-site such as macro-site 110a is typically itself operatively coupled with a core network such as core network 128a while a micro-site typically lacks an operative connection to a core network.

In another respect the communication latency between an end-client and an edge computing resource of a macro-site may be on the order of 10 milliseconds. The communication latency between an end-client and an edge computing resource of a micro-site may be on the order of 1-2 milliseconds. It shall be appreciated that latency may refer to forward and reverse communication link times and rather than a singular link.

Macro-site 110a may be connected to a core network 128a by fiber-optic line 129a. Core network 128a may be configured and provided in a number of forms. For example, core network 128a may comprise the public Internet or world wide web, a tier 1 network with a settlement-free peering relationship with other networks on the public Internet, a tier 2 network with a settlement-free peering relationship with some but not all other networks on the public Internet and peering relationship with some but not all other networks on the public Internet, or a tier 3 network with only peering relationships the other networks on the public Internet. Fiber-optic line 129a may likewise be provided in a number of forms providing suitable bandwidth and other transmission capabilities suitable for a given form of core network 128a as will occur to one skilled in the art with the benefit and insight of the present disclosure.

μ-MECRN 120a may be operatively connected to a plurality of repeaters 121a by a corresponding plurality of fiber-optic lines 131. μ-MECRN 120a may be operatively connected to μ-MECRN 120n by one or more fiber-optic communication lines 132 which may be locally distributed within the cluster's coverage area that is geographically limited. Preferably, no gateways are provided or required to establish the operative connection between μ-MECRN 120a and μ-MECRN 120n or the operative connection between μ-MECRN 120a and the plurality of repeaters 121a. In some embodiments, however, one or more such gateways be so provided.

μ-MECRN 120a may comprises radio equipment which may comprise one or more antennae, one or more sets of transmitter/receivers or transceivers, one or more digital signal processors, one or more controllers modules and one or more power supplies. μ-MECRN 120a may be configured and operable to send and receive wireless communications via its radio equipment and/or via one or more of the plurality of repeaters 121a.

μ-MECRN 120n may be operatively connected to a plurality of repeaters 121n by a corresponding plurality of fiber-optic lines 133. μ-MECRN 120n may be operatively connected to μ-MECRN 120b by one or more fiber-optic communication lines 134. Preferably, no gateways are provided or required to establish the operative connection between μ-MECRN 120n and μ-MECRN 120b or the operative connection between μ-MECRN 120n and the plurality of repeaters 121n. In some embodiments, however, one or more such gateways may be so provided

μ-MECRN 120n may comprises radio equipment which may comprise one or more antennae, one or more sets of transmitter/receivers or transceivers, one or more digital signal processors, one or more controllers modules and one or more power supplies. μ-MECRN 120n may be configured and operable to send and receive wireless communications via its radio equipment and/or via one or more of the plurality of repeaters 121n.

μ-MECRN 120n may be operatively connected to macro-site 110a by one or more fiber-optic communication lines 133 and a gateway 115n which is configured and operable to manage communication between a network domain of μ-MECRN 120n and a network domain of macro-site 110a. In some embodiments, macro-site 110a may be similarly operatively coupled with one or more additional μ-MECRN. In some embodiments, μ-MECRN 120n may additionally or alternatively be similarly operatively coupled with one or more other macro-sites. In some embodiments, μ-MECRN 120n may be coupled with macro-site 110a or another macro-site indirectly, for example, via another μ-MECRN.

μ-MECRN 120b may be operatively connected to a plurality of repeaters 121b by a corresponding plurality of fiber-optic lines 135. Preferably, no gateways are provided or required to establish the operative connection between μ-MECRN 120b and the plurality of repeaters 121b. In some embodiments, however, one or more such gateways may be so provided

μ-MECRN 120b may comprises radio equipment which may comprise one or more antennae, one or more sets of transmitter/receivers or transceivers, one or more digital signal processors, one or more controllers modules and one or more power supplies. μ-MECRN 120b may be configured and operable to send and receive wireless communications via its radio equipment and/or via one or more of the plurality of repeaters 121b.

μ-MECRN 120b may be operatively connected to macro-site 110b by one or more fiber-optic communication lines 136 and a gateway 115b which is configured and operable to manage communication between a network domain of μ-MECRN 120b and a network domain of macro-site 110b. The illustrated embodiment depicts a single gateway 115b with particular positioning and connectivity relationships with the one or more fiber-optic communication lines 136. It shall be appreciated that other embodiments may include a plurality of gateways and that one or more gateways associated with fiber-optic communication lines 136 may be provided with other positioning and/or other connectivity relationships with the one or more fiber-optic communication lines 136.

Macro-site 110b may be connected to a core network 128b by fiber-optic line 129b. Core network 128b and fiber-optic line 129b may be configured and provided in a number of forms such as those described in connection with core network 128a and fiber-optic line 129a.

μ-MECRN 120a, 120b, 120n may be configured to provide a redundant and distributed edge computing and wireless communication architecture. In one aspect, μ-MECRN 120a, 120b, 120n may provide respective locally fed node clusters 150a, 150b, 150n. Node clusters 150a, 150b, 150n may include redundant or over-determined wireless communication and micro-edge computing capacities. For example, μ-MECRN 120a and its associated repeater 121a may include redundant or over-determined wireless communication and edge computing capacities effective to provide client-to-modular edge computing path latencies on the order of about 1-2 milliseconds such that communication between a client (e.g., an autonomous vehicle system) and a modular edge computing (MEC) system experiences a latency of less than about 2 milliseconds, less than about 1.5 milliseconds, or less than about 1 milliseconds. μ-MECRN 120b and its associated repeater 121b, and μ-MECRN 120n and its associated repeaters 121n may provide substantially similar wireless communication and edge computing capacities effective to provide client-to-MEC path latencies on the order of about 1-2 milliseconds.

μ-MECRN 120a, 120b, 120n may also be configured to provide communication between or across locally fed node clusters 150a, 150b, 150n, effective to provide MEC-to-MEC path latencies on the order of about 1-2 milliseconds such that communication between a MEC of one of μ-MECRN 120a, 120b, 120n and another of μ-MECRN 120a, 120b, 120n experiences a latency of less than about 2 milliseconds, less than about 1.5 milliseconds, or less than about 1 milliseconds. It shall be appreciated that the term about with respect to latency refers to and encompasses functionally acceptable tolerances for a given client (e.g., a +/−% tolerance acceptable for a given autonomous vehicle system) as well outliers or functionally acceptable excursions from statistical averages or other metrics utilized to measure latency.

The aforementioned redundant or over-determined wireless communication and edge computing capacities may provide hand-off operation between or across locally fed node clusters 150a, 150b, 150n. For example, as autonomous vehicle 190 travels between locally fed node cluster 150b and locally fed node cluster 150n, it may concurrently communicate with a repeater 121b of locally fed node cluster 150b as indicated by arrow 192b and a repeater 121n of locally fed node cluster 150n as indicated by arrow 192n. MEC of μ-MECRN 120b and MEC of μ-MECRN 120n may concurrently receive information from and transmit information to autonomous vehicle 190 which may arbitrate between the received information. In some embodiments, MEC of μ-MECRN 120b and MEC of μ-MECRN 120n may communicate with one another to reconcile or arbitrate information communicated to autonomous vehicle 190. It shall be appreciated that the foregoing operation is an example of intra-locally fed node cluster redundant or over-determined wireless communication and edge computing capacity.

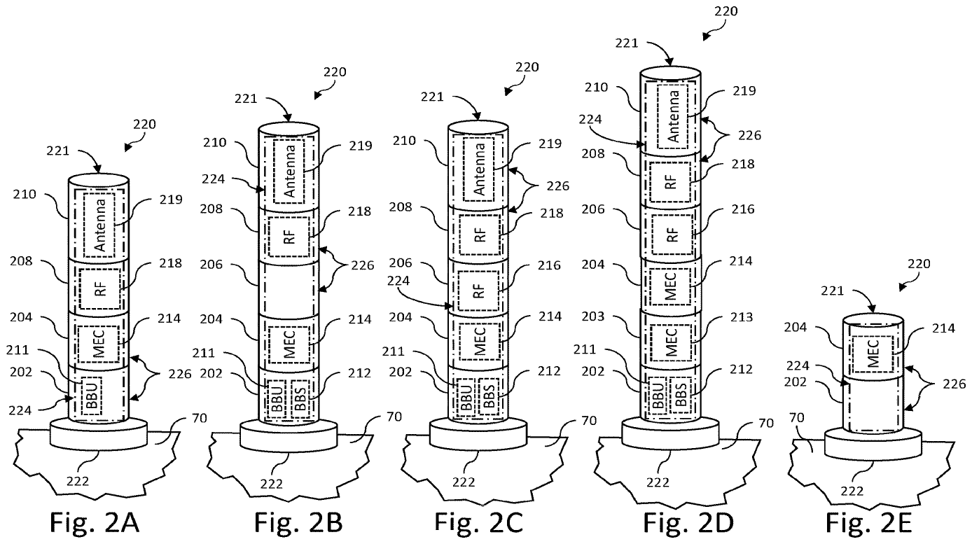

With reference to FIGS. 2A-2D, there is illustrated an example embodiment of a μ-MECRN 220 in a plurality of states of deployment. It shall be appreciated that the illustrated states are provided several examples and the plurality of states of deployment may comprise a number of other states of deployment.

μ-MECRN 220 comprises a housing 221 comprising a base 222 and a support frame 224 coupled with and extending upward from the base 222. Housing 221 may include one or more exterior shell sections or panels 226 coupled with and covering one or more areas of the support frame 224. It shall be appreciated that only some of exterior sections or panels 226 are labeled in the illustrated example. Furthermore, support frame 224 is depicted schematically and may have different physical configurations or structures in various embodiments. Support frame 224 may be operatively coupled with and supported by a ground anchor of base 222 which may, in turn, be fixedly coupled with an underlying grounds surface 70. In some embodiments, the load bearing capability of the ground anchor of base 222 may be overbuilt or overdetermined (e.g., by depth of ground anchoring, number of ground anchors, or otherwise) relative to what is strictly necessary to accommodate the addition of compartments or other expansion, extension, or addition to μ-MECRN 220. It is also contemplated that a μ-MECRN may be provided in other configurations which are modular or augmentable in a horizontal or other non-vertical direction.

Support frame 224 and exterior sections or panels 226 may provide a plurality of compartments configured and operable to house electronic components. μ-MECRN 220 may allow the number of such compartments to be varied by addition or removal of sections or portions of Support frame 224 and exterior sections or panels 226. Furthermore, the electronic components provided in the plurality of compartments may be varied, for example, by adding, removing, or swapping out components in a given compartment. It shall be appreciated that μ-MECRN provides at least two domains of modular scalability by being configured both to provide variation in number of compartments and variation in the electronic equipment contained in such compartments. Several examples of such variation are depicted in FIGS. 2A-2D and described herein.

In the state of deployment illustrated in FIG. 2A, support frame 224 and exterior panels 226 of μ-MECRN 220 are configured to comprise compartments 202, 204, 208, 210. Compartment 202 is configured and provided with base band unit (BBU) 211 which may be communicatively coupled with fiber-optic communication lines and other electronic components of μ-MECRN 220. Compartment 202 is configured and provided as a partially empty compartment, meaning that it has the capacity to house electronic components but such components have not been provided. Compartment 204 is configured and provided with mobile edge computing components (MEC) 214. Compartment 208 is configured and provided with cellular or other wireless radio frequency transceiver or associated hardware components (RF) 218 also sometimes referred to as a radio head or radio or wireless base station electronics. Compartment 210 is configured and provided with antenna 219. In the illustrated state of deployment μ-MECRN 220 may function as a hybrid or combined mobile edge computing and wireless base station communication platform.

In the state of deployment illustrated in FIG. 2B, support frame 224 and exterior panels 226 of μ-MECRN 220 are configured to provide an additional comprise compartments 202, 204, 206, 208, 210, wherein compartment 206 is an added compartment relative to the state of deployment illustrated in FIG. 2A. The addition of compartment 206 may be provided in a number of manners. In the illustrated example, addition of compartment 206 is provided by extending support frame 224, such as by adding frame structure to a terminus or an intermediate portion of support frame 224, and providing additional exterior sections or panels 226. In other embodiments, addition of compartment 206 may be provided in other manners, for example, by subdividing existing compartments, or by additions to support frame 224 in other dimensions or directions. The addition of compartments may preferably be provided without modification or variation of the ground anchor of base 222 and/or without enlargement of the physical footprint of μ-MECRN 220 relative to underlying grounds surface 70.

In the state of deployment illustrated in FIG. 2A, electronic equipment has been added to compartment 202 in the form of backup battery system (BBS) 212. Compartment 204 is configured and provided with MEC 214. Compartment 206 is configured and provided as an empty compartment, meaning that it has the capacity to house electronic components but such components have not been provided. Compartment 208 is configured and provided with cellular or other wireless radio frequency transceiver or associated hardware components (RF). Compartment 210 is configured and provided with antenna 219.

In the illustrated state of deployment μ-MECRN 220 may function as a hybrid or combined mobile edge computing, wireless base station communication, and backup power platform. It shall be appreciated that the addition of BBS 212 to the state of deployment illustrated in FIG. 2A may also have been accomplished in other manners, for example, by adding BBS to compartment 206 or by another compartment which may be subdivided or compartmentalized to house multiple categories of electronic components according to the present disclosure.

The state of deployment illustrated in FIG. 2B is an example of prophetic expansion enabled by the multiple domains of modular scalability of μ-MECRN 220. Such prophetic expansion may reduce the number of visits to the physical location of μ-MECRN 220 by a given set of service personnel. For example, the service personnel required for addition or incorporation of BBS 212 and compartment 206 may overlap partially or completely and may be greater in number, skill, and/or qualification that the service personnel required for addition or incorporation of additional MEC components or RF components.

In the state of deployment illustrated in FIG. 2C, electronic equipment has been added to compartment 206 in the form of RF 216. Compartment 202 is configured and provided with BBU 211 and BBS 212. Compartment 204 is configured and provided with MEC 214. Compartment 206 is configured and provided as an empty compartment, meaning that it has the capacity to house electronic components but such components have not been provided. Compartment 208 is configured and provided with cellular or other wireless radio frequency transceiver or associated hardware components (RF). Compartment 210 is configured and provided with antenna 219.

In the illustrated state of deployment μ-MECRN 220 may function as a hybrid or combined mobile edge computing, wireless base station communication, and backup power platform with increased wireless base station communication capability relative to the state of deployment illustrated in FIGS. 2A and 2B. Such additional capacity may be provided in anticipation of or in response to added communication demand on μ-MECRN 220, for example due to population or usage changes in the geographic region of μ-MECRN 220. Such changes may result from a number of circumstances including, for example, construction of new residential and/or business or commercial infrastructure, increases in human or wireless customer population, increases in penetration of internet-of-things (IoT) infrastructure, and/or increases in adoption of wireless-based communication platforms such as could occur with increased presence of autonomous or self-driving vehicles.

In the state of deployment illustrated in FIG. 2D, support frame 224 and exterior panels 226 of μ-MECRN 220 are configured to provide an additional comprise compartments 202, 203, 204, 206, 208, 210, wherein compartment 203 is an added compartment relative to the state of deployment illustrated in FIG. 2A. The addition of compartment 203 may be provided in a number of manners. In the illustrated example, addition of compartment 203 may be provided by extending support frame 224, such as by adding frame structure to a terminus or an intermediate portion of support frame 224, and providing additional exterior sections or panels 226. In other embodiments, addition of compartment 203 may be provided in other manners, for example, by subdividing existing compartments, or by additions to support frame 224 in other dimensions or directions. The addition of compartments may preferably be provided without modification or variation of the ground anchor of base 222 and/or without enlargement of the physical footprint of μ-MECRN 220 relative to underlying grounds surface 70.

In the state of deployment illustrated in FIG. 2D, electronic equipment has been added concurrent with the addition of compartment 203 in the form of MEC 213. Compartment 202 is configured and provided with BBU 211 and BBS 212. Compartment 204 is configured and provided with MEC 214. Compartment 206 is configured and provided as an empty compartment, meaning that it has the capacity to house electronic components but such components have not been provided. Compartment 208 is configured and provided with cellular or other wireless radio frequency transceiver or associated hardware components (RF). Compartment 210 is configured and provided with antenna 219.

In the illustrated state of deployment μ-MECRN 220 may function as a hybrid or combined mobile edge computing, wireless base station communication, and backup power platform with increased mobile edge computing capability relative to the state of deployment illustrated in FIGS. 2A-2C. Such additional capacity may be provided in anticipation of or in response to added edge computing demand on μ-MECRN 220, for example due to population or usage changes in the geographic region of μ-MECRN 220. Such changes may result from a number of circumstances including, for example, construction of new residential and/or business or commercial infrastructure, increases in human or wireless customer population, increases in penetration of internet-of-things (IoT) infrastructure, and/or increases in adoption of wireless-based communication platforms such as could occur with increased presence of autonomous or self-driving vehicles.

In the state of deployment illustrated in FIG. 2E, μ-MECRN 220 is provided in a reduced state of deployment wherein MEC 214 is provided in compartment 204 and compartment 202 is provided as an empty compartment. It shall be appreciated that state of deployment illustrated in FIG. 2E is one example of a μ-MECRN 220 installation wherein full wireless communication capability is not provided in at least one state of deployment.

In the illustrated state of deployment μ-MECRN 220 may function as a hybrid or combined mobile edge computing, wireless base station communication, and backup power platform with increased mobile edge computing capability relative to the state of deployment illustrated in FIGS. 2A-2C. Such additional capacity may be provided in anticipation of or in response to added edge computing demand on μ-MECRN 220, for example due to population or usage changes in the geographic region of μ-MECRN 220. Such changes may result from a number of circumstances including, for example, construction of new residential and/or business or commercial infrastructure, increases in human or wireless customer population, increases in penetration of internet-of-things (IoT) infrastructure, and/or increases in adoption of wireless-based communication platforms such as could occur with increased presence of autonomous or self-driving vehicles.

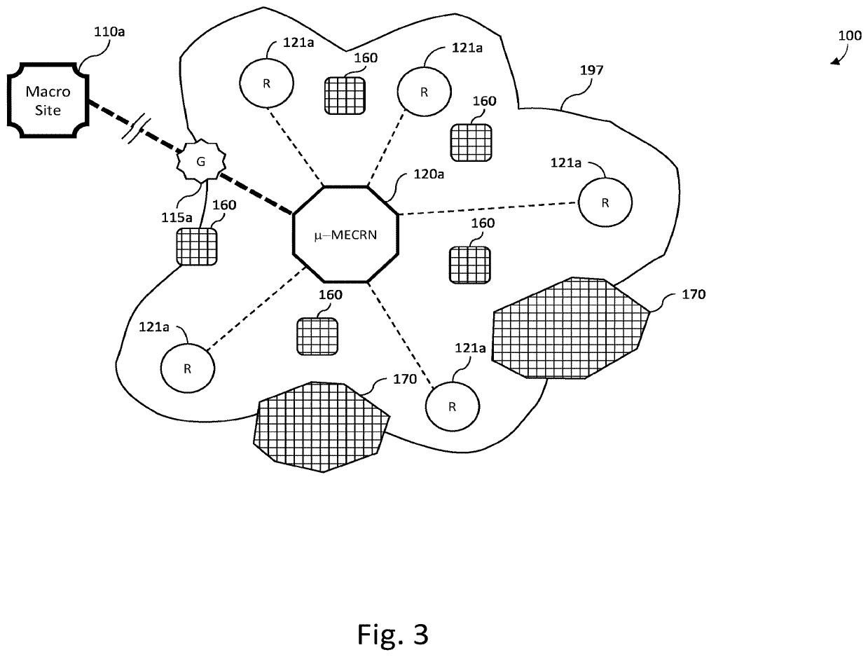

With reference to FIGS. 3-7, there is illustrated examples of network 100 in a plurality of states of deployment in an environment comprising a plurality of obstructions such as obstructions 160 and obstructions 170. It shall be appreciated that obstructions 160 and obstructions 170 may comprise physical obstructions limiting the physical placement of components of network 100 and/or communication obstructions limiting the wireless communication area of network 100.

In the state of deployment illustrated in FIG. 3, network 100 comprises μ-MECRN 120a, its associated repeaters 121a, gateway 115a, and macro-site 110a, as well as their fiber-optic communication lines which are indicated with dashed lines but not labeled in FIG. 3. The illustrated state of deployment provides a wireless communication area 197 for network 100.

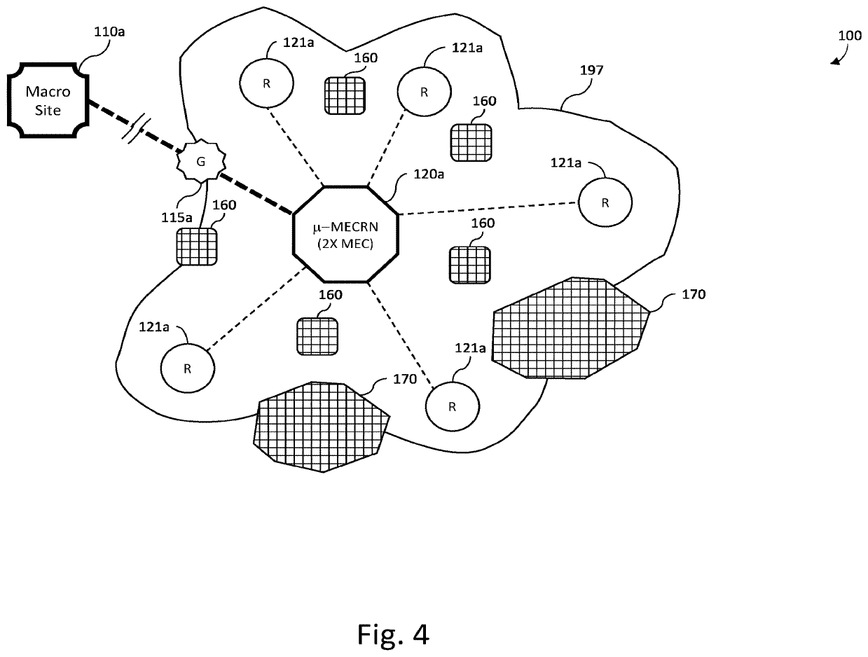

In the state of deployment illustrated in FIG. 4, network 100 has substantially the same physical footprint as the state of deployment illustrated in FIG. 3 but μ-MECRN 120a has been augmented to provide additional mobile edge computing capability (2X MEC).

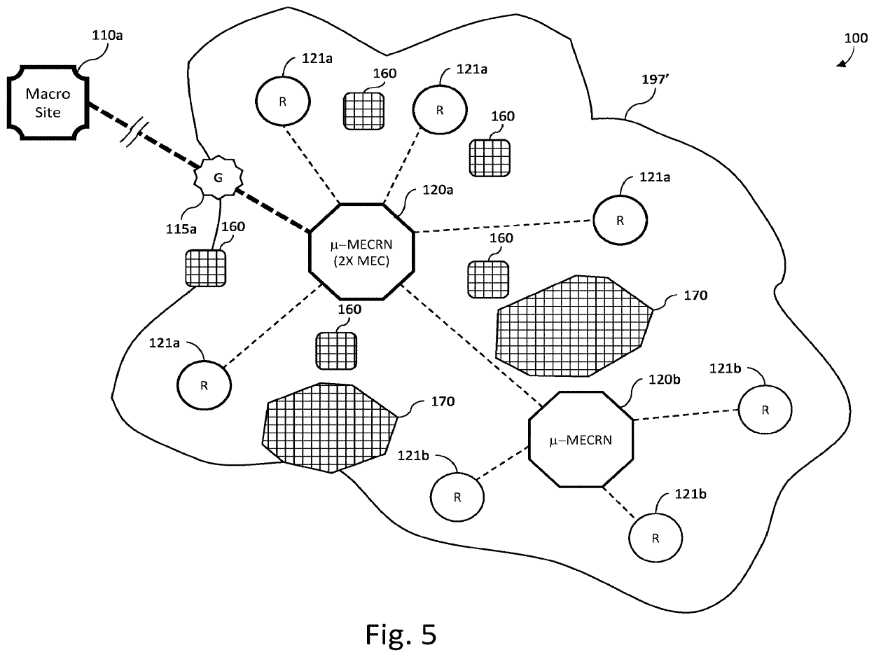

In the state of deployment illustrated in FIG. 5, network 100 has an increased physical footprint relative to the state of deployment illustrated in FIGS. 3 and 4 via addition of μ-MECRN 120b, its associated repeaters 121b and their fiber-optic communication lines which are indicated with dashed lines but not labeled, and one or more fiber-optic communication lines communicatively coupling μ-MECRN 120a and 120b which are also indicated with dashed lines but not labeled. The illustrated state of deployment provides a wireless communication area 197′ for network 100 which is expanded relative to wireless communication area 197.

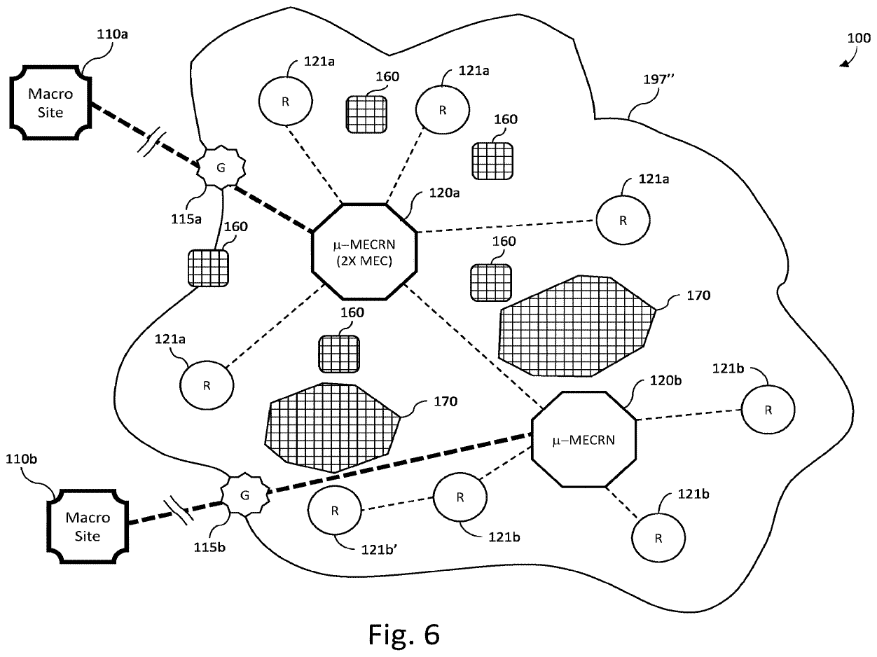

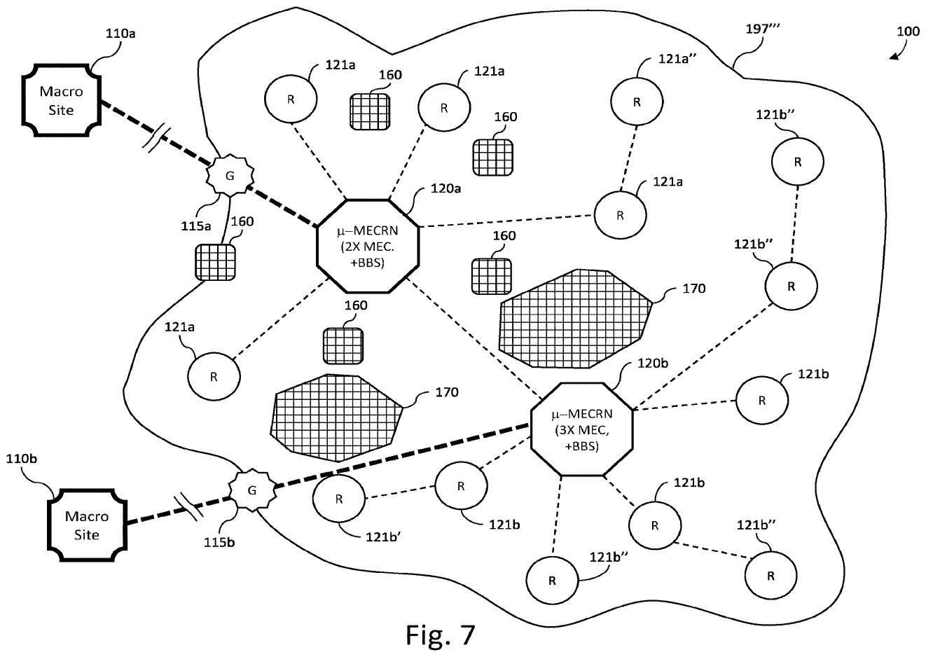

In the state of deployment illustrated in FIG. 6, network 100 has an increased physical footprint relative to the state of deployment illustrated in FIG. 5 via addition of an additional repeater 121b′ and its fiber-optic communication lines which are indicated with dashed lines but not labeled and communicatively couple repeater 121b′ with μ-MECRN 120b. The illustrated state of deployment provides a wireless communication area 197″ for network 100 which is expanded relative to wireless communication area 197′. In FIG. 7, the physical footprint of network 100 has also increased via communicative coupling macro-site 110b via gateway 115b and fiber-optic communication lines which are indicated with dashed lines but not labeled.

In the state of deployment illustrated in FIG. 7, network 100 has an increased physical footprint relative to the state of deployment illustrated in FIG. 6 via addition of additional repeaters 121a″ and 121b″ and their fiber-optic communication lines which are indicated with dashed lines but not labeled and communicatively couple repeater additional repeater 121a″ with μ-MECRN 121a and additional repeater 121b″ with μ-MECRN 120b. The illustrated state of deployment provides a wireless communication area 197″″ for network 100 which is expanded relative to wireless communication area 197″. In the state of deployment of FIG. 7, μ-MECRN 120a has been augmented to provide additional mobile edge computing capability (3X MEC). Additionally, μ-MECRN 120a and μ-MECRN 120b have been augmented to provide backup battery systems (BBS).

It shall be appreciated that network 100 provides a plurality of domains of modular scalability by μ-MECRN 120a and μ-MECRN 120b being configured both to provide variation in number of compartments and variation in the electronic equipment contained in such compartments, by the addition of fiber-optic lines coupling μ-MECRN 120a and μ-MECRN 120b to repeaters, fiber-optic lines coupling μ-MECRN 120a and μ-MECRN 120b, and fiber-optic lines coupling μ-MECRN 120a and μ-MECRN 120b with macro-site 110a and macro-site 110b, respectively. This scalability may provide or facilitate a number of network characteristics. Some such characteristics include distribution of backup battery systems (BBS) among a plurality of μ-MECRN. Some such characteristics include decrease latency in intra-μ-MECRN communication, μ-MECRN-repeater communication, and μ-MECRN-repeater communication. Some such characteristics include minimization of μ-MECRN footprint distribution or disruption in connection with network expansion. Some such characteristics include distribution of mobile edge computing (MEC) capacity and equipment among a plurality of μ-MECRN.
A first example embodiment, is a network comprising: a plurality of modular edge computing radio network (μ-MECRN) installations, each of the plurality of μ-MECRN installations being configurable to provide a plurality of compartments including an antenna being provided in at least a first one of the plurality of compartments, wireless base station electronics in operative communication with the antenna being provided in at least a second one of the plurality of compartments, and an edge computing system being provided in at least a third one of the plurality of compartments; wherein at least two of the plurality μ-MECRN installation are communicatively coupled by one or more fiber-optic communication lines, and each of the plurality of μ-MECRN is scaleable in at least two domains to incorporate additional electronic components.
A second example embodiment includes the features of the first example embodiment, wherein each of the plurality of μ-MECRN installations comprises a freestanding tower.
A third example embodiment includes the features of the second example embodiment, wherein the freestanding tower is coupled with a ground anchor.
A fourth example embodiment includes the features of the first example embodiment, wherein each of the plurality of μ-MECRN is scaleable in at least two domains to incorporate additional electronic compartments without modifying a ground area footprint of the μ-MECRN.
A fifth example embodiment includes the features of the fourth example embodiment, wherein the at least two domains comprise addition of compartments by vertical extension of the μ-MECRN.
A sixth example embodiment includes the features of the fourth example embodiment, wherein the at least two domains comprise addition of electronic components to a preexisting compartment of the μ-MECRN.
A seventh example embodiment includes the features of the first example embodiment, wherein at least one of the plurality of μ-MECRN installations is communicatively coupled with a macro-site installation by one or more fiber-optic communication lines.
An eighth example embodiment includes the features of the seventh example embodiment, wherein the macro-site installation is communicatively coupled with a core network.
A ninth example embodiment includes the features of the first example embodiment, wherein the at least two of the plurality μ-MECRN installation are communicatively coupled by one or more fiber-optic communication lines are communicatively coupled without use of an intermediate gateway.
A tenth example embodiment includes the features of the first example embodiment, wherein one or more of the plurality of μ-MECRN installations is communicatively coupled with one or more radio repeaters.
An eleventh example embodiment includes the features of the first example embodiment, wherein each of the plurality of μ-MECRN installations comprises a plurality of wireless radio repeaters operatively coupled with a respective μ-MECRN installation to establish a locally fed node cluster.
A twelfth example embodiment includes the features of the eleventh example embodiment, wherein the locally fed node cluster provides client-to MEC communication latency of less than about 2 milliseconds between a wireless client device and one of the μ-MECRN and one of the plurality of wireless radio repeaters.
A thirteenth example embodiment includes the features of the eleventh example embodiment, wherein the locally fed node cluster of each of the plurality of μ-MECRN is configured to provide redundant wireless communication and edge computing capacities for the locally fed node cluster.
A fourteenth example embodiment includes the features of the eleventh example embodiment, wherein a plurality of locally fed node clusters are configured to provide redundant wireless communication and edge computing capacities across or between the plurality of locally fed node cluster.
A fifteenth example embodiment includes the features of the first example embodiment, wherein one or more of the plurality of μ-MECRN installations are configured provide the antenna in at least the first one of the plurality of compartments.
A sixteenth example embodiment includes the features of the first example embodiment, wherein one or more of the plurality of μ-MECRN installations are configured provide the wireless base station electronics in the at least the a second one of the plurality of compartments.
A seventeenth example embodiment includes the features of the first example embodiment, wherein one or more of the plurality of μ-MECRN installations are configured provide the edge computing system being in at least the third one of the plurality of compartments.
An eighteenth example embodiment is a method comprising: installing in a predetermined geography a plurality of modular edge computing radio network (μ-MECRN) installations, each of the plurality of μ-MECRN installations being configurable to provide a plurality of compartments including an antenna being provided in at least a first one of the plurality of compartments, wireless base station electronics in operative communication with the antenna being provided in at least a second one of the plurality of compartments, and an edge computing system being provided in at least a third one of the plurality of compartments; communicatively coupling at least two of the plurality μ-MECRN installation by one or more fiber-optic communication lines, and scaling at least one of the plurality of μ-MECRN is scaleable in at least two domains to incorporate additional electronic components.
A nineteenth example embodiment includes the features of the eighteenth example embodiment, wherein each of the plurality of μ-MECRN installations comprises a freestanding tower.
A twentieth example embodiment includes the features of the nineteenth example embodiment, wherein the freestanding tower is coupled with a ground anchor.
A twenty-first example embodiment includes the features of the eighteenth example embodiment, wherein said scaling at least one of the plurality of μ-MECRN occurs without modifying a ground area footprint of the μ-MECRN.
A twenty-second example embodiment includes the features of the twenty-first example embodiment, wherein said scaling at least one of the plurality of μ-MECRN comprises adding one or more compartments by vertical extension of the μ-MECRN.
A twenty-third example embodiment includes the features of the twenty-first example embodiment, wherein said scaling at least one of the plurality of μ-MECRN comprise adding one or more electronic components to a preexisting compartment of the μ-MECRN.
A twenty-fourth example embodiment includes the features of the eighteenth example embodiment, comprising communicatively coupling at least one of the plurality of μ-MECRN installations with a macro-site installation by one or more fiber-optic communication lines.
A twenty-fifth example embodiment includes the features of the twenty-fourth example embodiment, wherein the macro-site installation is communicatively coupled with a core network.
A twenty-sixth example embodiment includes the features of the eighteenth example embodiment, wherein the communicatively coupling the at least two of the plurality μ-MECRN installation comprises communicatively coupling without use of an intermediate gateway.
A twenty-seventh example embodiment includes the features of the eighteenth example embodiment, comprising communicatively coupling one or more of the plurality of μ-MECRN installations is communicatively with one or more radio repeaters.
A twenty-eighth example embodiment includes the features of the eighteenth example embodiment, wherein each of the plurality of μ-MECRN installations comprises a plurality of wireless radio repeaters operatively coupled with a respective μ-MECRN installation to establish a locally fed node cluster.
A twenty-ninth example embodiment includes the features of the twenty-eighth example embodiment, wherein the locally fed node cluster provides client-to MEC communication latency of less than about 2 milliseconds between a wireless client device and one of the μ-MECRN and one of the plurality of wireless radio repeaters.
A thirtieth example embodiment includes the features of the twenty-eighth example embodiment, wherein the locally fed node cluster of each of the plurality of μ-MECRN is configured to provide redundant wireless communication and edge computing capacities for the locally fed node cluster.
A thirty-first example embodiment includes the features of the twenty-eighth example embodiment, wherein a plurality of locally fed node clusters are configured to provide redundant wireless communication and edge computing capacities across or between the plurality of locally fed node cluster.
A thirty-second example embodiment includes the features of the eighteenth example embodiment, wherein one or more of the plurality of μ-MECRN installations are configured provide the antenna in at least the first one of the plurality of compartments.
A thirty-third example embodiment includes the features of the eighteenth example embodiment, wherein one or more of the plurality of μ-MECRN installations are configured provide the wireless base station electronics in the at least the a second one of the plurality of compartments.
A thirty-fourth example embodiment includes the features of the eighteenth example embodiment, wherein one or more of the plurality of μ-MECRN installations are configured provide the edge computing system being in at least the third one of the plurality of compartments.

It shall be appreciated that terms such as “a non-transitory memory,” “a non-transitory memory medium,” and “a non-transitory memory device” refer to a number of types of devices and storage mediums which may be configured to store information, such as data or instructions, readable or executable by a processor or other components of a computer system and that such terms include and encompass a single or unitary device or medium storing such information, multiple devices or media across or among which respective portions of such information are stored, and multiple devices or media across or among which multiple copies of such information are stored.

It shall be appreciated that terms such as “determine,” “determined,” “determining” and the like when utilized in connection with a control method or process, an electronic control system or controller, electronic controls, or components or operations of the foregoing refer inclusively to a number of acts, configurations, devices, operations, and techniques including, without limitation, calculation or computation of a parameter or value, obtaining a parameter or value from a lookup table or using a lookup operation, receiving parameters or values from a datalink or network communication, receiving an electronic signal (e.g., a voltage, frequency, current, or pulse-width modulation (PWM) signal) indicative of the parameter or value, receiving output of a sensor indicative of the parameter or value, receiving other outputs or inputs indicative of the parameter or value, reading the parameter or value from a memory location on a computer-readable medium, receiving the parameter or value as a run-time parameter, and/or by receiving a parameter or value by which the interpreted parameter can be calculated, and/or by referencing a default value that is interpreted to be the parameter value.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. It should be understood that while the use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A system comprising:
a plurality of modular edge computing radio network (μ-MECRN) installations, each of the plurality of μ-MECRN installations being configurable to provide a plurality of compartments including an antenna being provided in at least a first one of the plurality of compartments, wireless base station electronics in operative communication with the antenna being provided in at least a second one of the plurality of compartments, and an edge computing system being provided in at least a third one of the plurality of compartments; wherein
at least two of the plurality μ-MECRN installation are communicatively coupled by one or more fiber-optic communication lines, and
each of the plurality of μ-MECRN is scaleable in at least two domains to incorporate additional electronic components.

2. The system of claim 1, wherein each of the plurality of μ-MECRN installations comprises a freestanding tower.

3. The system of claim 2, wherein the freestanding tower is coupled with a ground anchor.

4. The system of claim 1, wherein each of the plurality of μ-MECRN is scaleable in at least two domains to incorporate additional electronic compartments without modifying a ground area footprint of the μ-MECRN.

5. The system of claim 4, wherein the at least two domains comprise addition of compartments by vertical extension of the μ-MECRN.

6. The system of claim 4, wherein the at least two domains comprise addition of electronic components to a preexisting compartment of the μ-MECRN.

7. The system of claim 1, wherein at least one of the plurality of μ-MECRN installations is communicatively coupled with a macro-site installation by one or more fiber-optic communication lines.

8. The system of claim 7, wherein the macro-site installation is communicatively coupled with a core network.

9. The system of claim 1, wherein the at least two of the plurality μ-MECRN installation are communicatively coupled by one or more fiber-optic communication lines are communicatively coupled without use of an intermediate gateway.

10. The system of claim 1, wherein one or more of the plurality of μ-MECRN installations is communicatively coupled with one or more radio repeaters.

11. The system of claim 1, wherein each of the plurality of μ-MECRN installations comprises a plurality of wireless radio repeaters operatively coupled with a respective μ-MECRN installation to establish a locally fed node cluster.

12. The system of claim 11, wherein the locally fed node cluster provides client-to MEC communication latency of less than about 2 milliseconds between a wireless client device and one of the μ-MECRN and one of the plurality of wireless radio repeaters.

13. The system of claim 11, wherein the locally fed node cluster of each of the plurality of μ-MECRN is configured to provide redundant wireless communication and edge computing capacities for the locally fed node cluster.

14. The system of claim 11, wherein a plurality of locally fed node clusters are configured to provide redundant wireless communication and edge computing capacities across or between the plurality of locally fed node cluster.

15. The system of claim 1, wherein one or more of the plurality of μ-MECRN installations are configured provide the antenna in at least the first one of the plurality of compartments.

16. The system of claim 1, wherein one or more of the plurality of μ-MECRN installations are configured provide the wireless base station electronics in the at least the a second one of the plurality of compartments.

17. The system of claim 1, wherein one or more of the plurality of μ-MECRN installations are configured provide the edge computing system being in at least the third one of the plurality of compartments.

18. A method comprising:
installing in a predetermined geography a plurality of modular edge computing radio network (μ-MECRN) installations, each of the plurality of μ-MECRN installations being configurable to provide a plurality of compartments including an antenna being provided in at least a first one of the plurality of compartments, wireless base station electronics in operative communication with the antenna being provided in at least a second one of the plurality of compartments, and an edge computing system being provided in at least a third one of the plurality of compartments;
communicatively coupling at least two of the plurality μ-MECRN installation by one or more fiber-optic communication lines, and
scaling at least one of the plurality of μ-MECRN is scaleable in at least two domains to incorporate additional electronic components.

19. The method of claim 18, wherein each of the plurality of μ-MECRN installations comprises a freestanding tower.

20. The method of claim 19, wherein the freestanding tower is coupled with a ground anchor.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)
